(19) United States
(12) Patent Application Publication
(10) Pub. No.: US 2017/0149321 A1
(43) Pub. Date: May 25, 2017

(54) VIBRATION ELECTRICITY GENERATION DEVICE

(71) Applicant: STAR MICRONICS CO., LTD., Shizuoka (JP)

(72) Inventors: Takaharu Kato, Shizuoka (JP); Yoshiaki Fukai, Shizuoka (JP)

(21) Appl. No.: 15/402,402

(22) Filed: Jan. 10, 2017

Related U.S. Application Data
(63) Continuation of application No. PCT/JP2015/052098, filed on Jan. 27, 2015.

(30) Foreign Application Priority Data
Jul. 22, 2014 (JP) 2014-148645

(51) Int. Cl. H02K 35/02

(52) U.S. Cl. CPC H02K 35/02

(57) ABSTRACT

The vibration electricity generation device comprises a fixed unit and a movable unit supported on the fixed unit via a coil spring. The movable unit is configured to vibrate against resilient force of the coil spring thereby generating induced electromotive force. The coil spring is coupled to the movable unit in a position apart from the center position of the movable unit with respect to the vibration direction toward the opposite side of the position where the coil spring is coupled to the fixed unit. Even in the case the vibration electricity generation device is reduced in size with respect to the vibration direction, the length of the coil spring can be extended, thereby enhancing selection freedom of vibration frequency.

### CROSS-REFERENCE TO RELATED APPLICATION

This application is a continuation of International Patent Application No. PCT/JP2015/052098, filed on Jan. 27, 2015, which claimed priority of Japanese Patent Application No. 2014-148645 filed on Jul. 22, 2014. The contents of these applications are incorporated herein by reference in their entirety.

### BACKGROUND

(a) Field

The present invention relates to a vibration electricity generation device configured to generate induced electromotive force by using vibration.

(b) Description of the Related Art

A portable vibration electricity generation device configured to automatically generate electricity by movement such as an action of walking has been known to public.

For example, the Japanese Patent No. 5417719 discloses a vibration electricity generation device comprising a movable unit supported on a fixed unit via a coil spring wherein the movable unit is configured to vibrate against resilient force of the coil spring to generate induced electromotove force.

### SUMMARY

Conventionally, as shown in Japanese Patent No. 5417719, the coil spring is coupled to the movable unit in a position on the side of the position where the coil spring is coupled to the fixed unit rather than the center position of the movable unit with respect to the vibration direction.

In the case that the vibration electricity generation device is reduced in size with respect to the vibration direction, it would be difficult to secure enough length of the coil spring, thereby restricting selection freedom of vibration frequency. This would result in that the movable unit cannot be operated by a vibration frequency with a good power generation efficiency.

The purpose of the present invention is to solve the above problem, especially to provide a vibration electricity generation device configured to generate induced electromotive force by using vibration and capable of enhancing selection freedom of vibration frequency even in the case the vibration electricity generation device is reduced in size with respect to the vibration direction.

The invention comprises an improvement of the position where the coil spring is coupled to the movable unit.

In the vibration electricity generation device of the invention comprising a fixed unit and a movable unit supported on the fixed unit via a coil spring to vibrate against resilient force of the coil spring thereby generating induced electromotive force, the coil spring is coupled to the movable unit in a position apart from the center position of the movable unit with respect to the vibration direction toward the opposite side of the position where the coil spring is coupled to the fixed unit.

The vibration electricity generation device may be of any configuration as far as capable of generating induced electromotive force by using vibration of the movable unit. The movable unit or the fixed unit is not limited to a particular configuration.

The vibration direction is not limited to a particular direction. An example includes the up and down direction or the horizontal direction.

As far as the coil spring is coupled to the movable unit in a position apart from the center position of the movable unit with respect to the vibration direction toward the opposite side of the position where the coil spring is coupled to the fixed unit, the distance from the center position of the movable unit is not limited to a particular amount. Preferably, however, the coil spring may be coupled to the movable unit in a position apart from the center position of the movable unit with respect to the vibration direction by more than one-third of the distance from the center position of the movable unit to the end of the movable unit on the opposite side of the position where the coil spring is coupled to the fixed unit. More preferably, the coil spring may be coupled to the movable unit in a position apart from the center position of the movable unit with respect to the vibration direction by more than one-half of the distance from the center position of the movable unit to the end of the movable unit on the opposite side of the position where the coil spring is coupled to the fixed unit.

In the vibration electricity generation device of the invention, the movable unit supported on the fixed unit via the coil spring is configured to vibrate against elastic force of the coil spring. The coil spring is coupled to the movable unit in a position apart from the center position of the movable unit with respect to the vibration direction toward the opposite side of the position where the coil spring is coupled to the fixed unit. Advantageous effects are thereby achieved.

Even in the case the vibration electricity generation device is downsized with respect to the vibration direction, the length of the coil spring can be extended, allowing easy adjustment of spring constant and thereby enhancing selection freedom of vibration frequency.

Accordingly, in the vibration electricity generation device configured to generate induced electromotive force by using vibration, selection freedom of vibration frequency can be enhanced even in the case the vibration electricity generation device is reduced in size with respect to the vibration direction. The movable unit is thereby enabled to be operated by a vibration frequency with a good power generation efficiency

In the case the position where the coil spring is coupled to the movable unit is at the end of the movable unit on the opposite side of the position where the coil spring is coupled to the fixed unit, the length of the coil spring can be further extended, thereby further enhancing selection freedom of vibration frequency.

In the case the coil spring is configured by a coil springs set comprising first and second coil springs reversely directed, such combination of the coil springs improves spring function, thereby further enhancing selection freedom of vibration frequency.

In the case a plurality of coil springs are arranged in the direction perpendicular to the vibration direction, the movable unit is enabled to be operated in a smoother manner and selection freedom of vibration frequency can be enhanced.

In the case the fixed unit is configured to include a plate coil holder extending in the vibration direction and a conductive coil supported on the coil holder while the movable unit is configured to include magnet holders surrounding the coil holder and two pairs of magnets supported on the magnet holders on the front and back sides of the coil holder, and further the coil springs are arranged on the right and left sides of the coil holder with respect to the direction perpendicular to the plate thickness of the coil holder, the movable unit 40 can be operated in a further smoother manner in a vibration electricity generation device of a compact configuration.

### BRIEF DESCRIPTION OF THE DRAWINGS

FIG. 1 is a front view partly in section of an embodiment of a vibration electricity generation device.

FIG. 2A is a IIa-IIa line section view of FIG. 1.

FIG. 2B is a IIb-IIb line section view of FIG. 1.

FIG. 3 is a III-III line section view of FIG. 1.

FIG. 4 is an example of use of the vibration electricity generation device.

FIG. 5 is a similar view to FIG. 1 showing a vibration electricity generation device of the first modified embodiment.

FIG. 6 is a similar view to FIG. 1 showing a vibration electricity generation device of the second modified embodiment.

### DETAILED DESCRIPTION

The present invention according to the embodiment is being described referring to the drawings.

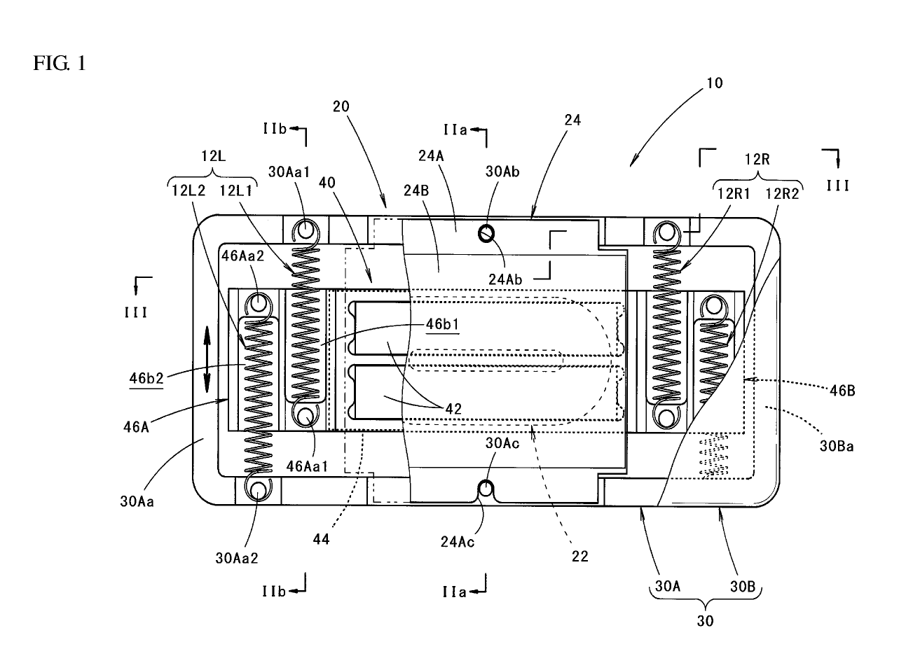

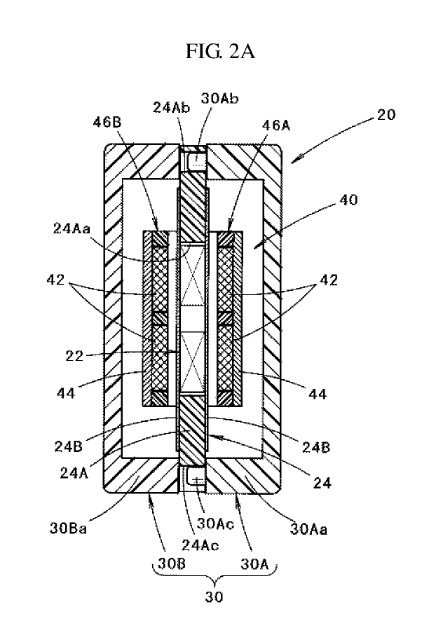

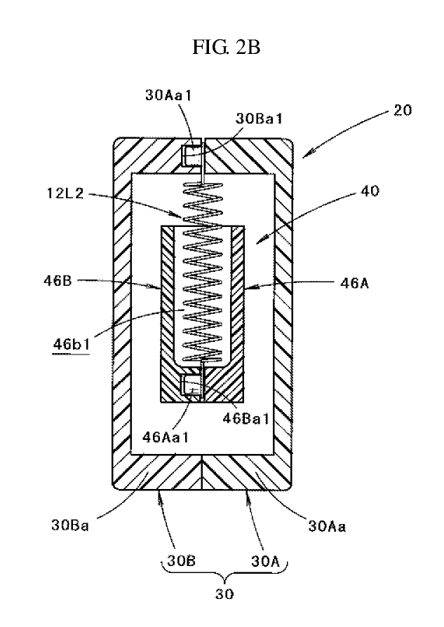

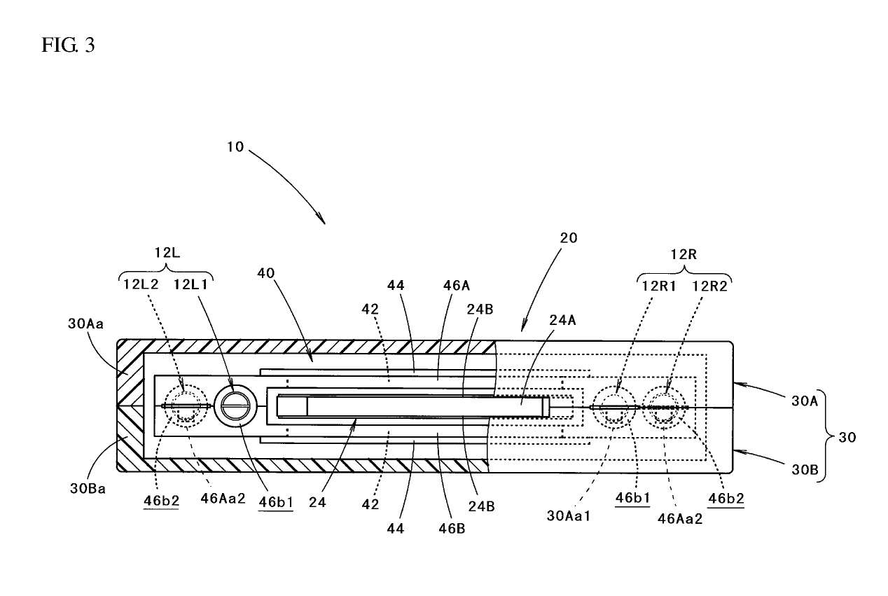

FIG. 1 is a front view partly in section of an embodiment of a vibration electricity generation device 10. FIG. 2A is a IIa-IIa line section view of FIG. 1. FIG. 2B is a IIb-IIb line section view of FIG. 1. FIG. 3 is a III-III line section view of FIG. 1.

The vibration electricity generation device 10, the size of which is 30 mm or less (for example, 20 mm to 25 mm) with respect to the up and down direction, includes a fixed unit 20 and a movable unit 40 supported on the fixed unit 20 via two pairs of coil springs sets 12L and 12R.

The movable unit 40 is configured to vibrate in the up and down direction as denoted in an arrow in FIG. 1 against resilient force of the pairs of coil springs sets 12L and 12R, thereby generating induced electromotive force.

The fixed unit 20 is being described.

The fixed unit 20 includes a coil holder 24 for supporting a conductive coil 22 and a circuit board (not shown) arranged in a housing 30.

The housing 30 has the shape of a horizontally long rectangle in a front view having a certain width in the front and back direction. The housing 30 includes a resin base 30A and a resin cover 30B for covering the base 30A from the front side. The base 30A and the cover 30B are symmetrical with respect to the front and back direction except part thereof.

The coil holder 24 includes a plate holder body 24A having the shape of a rectangle similar to a square with missing four corners in a front view and two friction reducing films 24B adhered to the front and back side of the holder body 24A.

The holder body 24A may be made of general purpose resin such as polycarbonate resin. The friction reducing films 24B may be made of ultrahigh molecular weight polyethylene or other materials.

The conductive coil 22 has the shape of a horizontally long oval.

The holder body 24A has a coil accommodating part 24Aa formed in the shape of a horizontally long oval and arranged at the center portion thereof with respect to the up and down direction. The friction reducing films 24B each is adhered to a region except the up and down ends of the holder body 24A.

The holder body 24A has a small through hole 24Ab at the horizontal center of the upper end portion thereof, penetrating the holder body 24A in the front and back direction. The holder body 24A has a recess 24Ac of the shape of an inverted U letter at the horizontal center of the lower end portion thereof.

The base 30A has positioning pins 30Ab and 30Ac respectively formed on the upper and lower end portions of a surrounding wall 30Aa.

The coil holder 24 is positioned with respect to the housing 30 in the up and down and the right and left directions by engagement of the recess 24Ac with the positioning pin 30Ac and insertion of the positioning pin 30Ab into the small hole 24Ab. The coil holder 24 is further positioned with respect to the housing 30 in the front and back direction by engagement of the cover 30B with the base 30A to hold the upper and lower end portions of the holder 24 from the front and back sides.

The holder body 24Aa has a groove (not shown) extending from the coil accommodating part 24Aa to the upper end portion of the holder body 24A. A pair of coil terminals (not shown) drawn from the conductive coil 22 is guided along the groove toward the circuit board.

The movable unit 40 is being described.

The movable unit 40 includes a pair of front and back magnet holders 46A and 46B surrounding the coil holder 24 with a gap kept therebetween in a plan view. On each of the magnet holders 46A and 46B, a yoke 44 and a pair of upper and lower magnets 42 are mounted.

The magnet holders 46A and 46B each may be made of resin formed in a horizontally long rectangle shape in a front view. The magnets 42 each may be a neodymium magnet or other magnets formed in a horizontally long rectangular parallelepiped shape. The yokes 44 each may be made of soft iron formed in a horizontally long rectangle shape.

The pair of upper and lower magnets 42 each are embedded in a pair of upper and lower through holes formed in the magnet holders 46A and 46B with the inner surfaces of the magnets 42 being coplanar with the inner surfaces of the magnet holders 46A and 46B each. The magnets 42 each are attracted to the yokes 44 by magnetic force, or may be positionally secured to the yokes by an adhesive.

The upper and lower magnets 42 are arranged in an opposite relationship in polarity. Such opposite relationship in polarity is also assured between the front and back yokes 44 in a manner that the upper magnet 42 on the front yoke 44 coincides with the lower magnet 42 on the back yoke 44 while the lower magnet 42 on the front yoke 44 coincides with the upper magnet 42 on the back yoke 44 in polarity.

Such configuration of the two pairs of upper and lower magnets 42 and the pair of front and back yokes 44 forms a magnetic circuit generating a magnetic flux in the space across the pairs of the magnets.

The pair of front and back magnet holders 46A and 46B are substantially of the same configuration and symmetrical to each other with respect to the right and left direction. The pair of magnet holders 46A and 46B are attached to each other by the magnetic force of the pairs of upper and lower magnets 42 and an adhesive with the magnet holder 46A abutting against the magnet holder 46B at the right and left ends.

The two pairs of coil springs sets 12L and 12R are being described.

The coil springs sets 12L and 12R are arranged in the housing 30 on the right and left sides of the coil holder 24. The coil springs sets 12L and 12R each are coupled to the movable unit 40 on the right and left ends of the magnet holders 46A and 46B.

The coil springs set 12L on the left side of the coil holder 24 and the coupling configuration thereof are being described.

The coil springs set 12L includes a first coil spring 12L1 and a second coil spring 12L2 horizontally adjacent to each other. The coil springs 12L1 and 12L2 having the same configuration are extended in the up and down direction reversely to each other. The coil springs 12L1 and 12L2 each may be a tension coil spring.

The magnet holders 46A and 46B have an insertion hole 46b1 for the first coil spring 12L1 and an insertion hole 46b2 for the second coil spring 12L2. The insertion holes 46b1 and 46b2 are horizontally adjacent to each other, extending in the up and down direction reversely to each other.

The insertion hole 46b1 is opened to the upper end of the magnet holders 46A and 46B and extended to the neighborhood of the lower end thereof. The insertion hole 46b2 is opened to the lower end of the magnet holders 46A and 46B and extended to the neighborhood of the upper end thereof. The insertion holes 46b1 and 46b2 each are formed in a cylindrical shape having a slightly larger inner diameter than the winding diameter of the first and second coil springs 12L1 and 12L2. The magnet holders 46A and 46B each have the half of the holes 46b1 and 46b2 formed each having a semi-cylindrical section of the same size.

The upper end of the first coil spring 12L1 inserted in the insertion hole 46b1 is coupled to the housing 30 and the lower end thereof is coupled to the movable unit 40. The lower end of the second coil spring 12L2 inserted in the insertion hole 46b2 is coupled to the housing 30 and the upper end thereof is coupled to the movable unit 40.

Specifically, the upper end of the first coil spring 12L1 is engaged with a protrusion 30Aa1 formed on the surrounding wall 30Aa of the base 30A. The protrusion 30Aa1 is engaged with a recess 30Ba1 formed on a surrounding wall 30Ba of the cover 30B.

The lower end of the first coil spring 12L1 is engaged with a protrusion 46Aa1 formed on the lower end of the magnet holder 46A on the back side. The protrusion 46Aa1 is engaged with a recess 46Ba1 formed on the lower end of the magnet holder 46B on the front side.

Specifically, the lower end of the second coil spring 12L2 is engaged with a protrusion 30Aa2 formed on the surrounding wall 30Aa of the base 30A. The protrusion 30Aa2 is engaged with a recess (not shown) formed on the surrounding wall 30Ba of the cover 30B.

The upper end of the second coil spring 12L2 is engaged with a protrusion 46Aa2 formed on the upper end of the magnet holder 46A on the back side. The protrusion 46Aa2 is engaged with a recess (not shown) formed on the upper end of the magnet holder 46B on the front side.

The region around the protrusions 30Aa1 and 30Aa2 on the surrounding wall 30Aa of the base 30A is stepped down on the front side. The region around the recesses on the surrounding wall 30Ba of the cover 30B is stepped down on the back side. The upper end of the first coil spring 12L1 and the lower end of the second coil spring 12L2 are thereby held from both the front and back sides.

Similarly, the region around the protrusions 46Aa1 and 46Aa2 on the magnet holder 46A is stepped down on the front side. The region around the recesses 46Ba1 and others on the magnet holder 46B is stepped down on the back side. The lower end of the first coil spring 12L1 and the upper end of the second coil spring 12L2 are thereby held from both the front and back sides.

The first and second coil springs 12L1 and 12L2 with the upper and lower ends thereof respectively engaged with the protrusions are elastically deformed, thereby subject to certain pre-tension force imparted thereto when the movable unit 40 is at the neutral position with respect to the vibration direction. The pre-tension force is set to the magnitude not to fall below zero even in the case the movable unit 40 is operated at the maximum amplitude.

The coil springs set 12R on the right side of the coil holder 24 and the coupling configuration thereof are being described.

The coil springs set 12R includes a first coil spring 12R1 and a second coil spring 12R2 horizontally adjacent to each other and extending in the up and down direction reversely to each other. The coil springs 12R1 and 12R2 are of the same configuration as the coil springs 12L1 and 12L2 and symmetrical thereto with respect to the right and left direction.

The coupling configuration of the coil springs 12R1 and 12R2 to the fixed unit 20 and the movable unit 40 is the same as that of the coil springs 12L1 and 12L2.

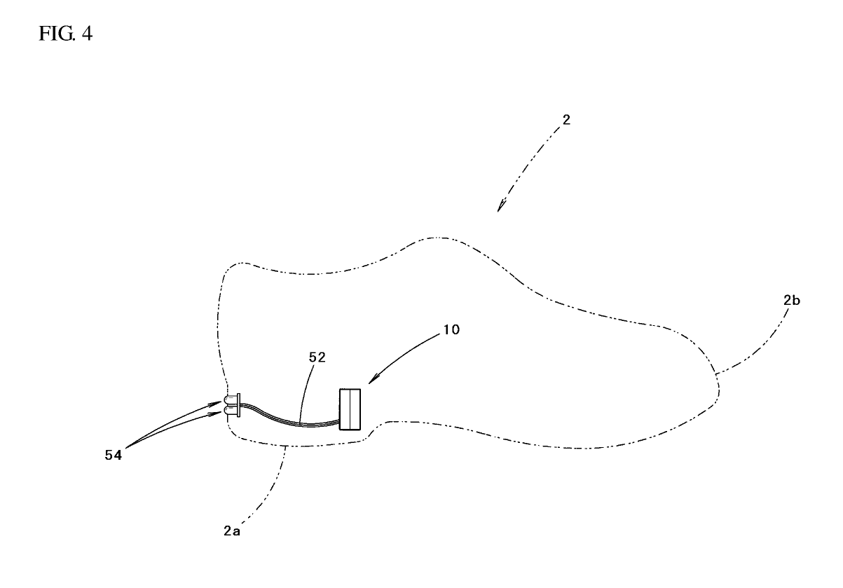

FIG. 4 is an example of use of the vibration electricity generation device 10.

The vibration electricity generation device 10 may be used in sports shoes 2.

The vibration electricity generation device 10 is embedded in a heel 2a of the shoe 2 with the front side of the vibration electricity generation device 10 facing toward a toe 2b of the shoe 2. The vibration electricity generation device 10 is electrically connected to two light emitting diodes 54 embedded at the back end of the heel 2a via a code 52 embedded in the heel 2a.

As a user wearing the shoes 2 walks or runs, a landing shock causes the movable unit 40 to vibrate in the up and down direction to generate induced electromotove force on the conductive coil 22, thereby providing alternate illumination of the light emitting diodes 54.

Advantageous effects of the present embodiment are being described.

In the vibration electricity generation device 10 of the embodiment, the movable unit 40 supported on the fixed unit 20 via the two pairs of coil springs sets 12L and 12R is configured to vibrate against elastic force of the first and second coil springs 12L1 and 12L2 of the coil spring set 12L and the first and second coil springs 12R1 and 12R2 of the coil spring set 12R. Each of the first and second coil springs 12L1, 12L2, 12R1, and 12R2 is coupled to the movable unit 40 in a position apart from the center position of the movable unit 40 with respect to the vibration direction (the center position with respect to the up and down direction) toward the opposite side of the position where each of the first and second coil springs 12L1, 12L2, 12R1, and 12R2 is coupled to the fixed unit 20. Advantageous effects are thereby achieved.

Even in the case the vibration electricity generation device 10 is downsized with respect to the vibration direction (the up and down direction), the length of the coil springs 12L1, 12L2, 12R1, and 12R2 can be extended, allowing easy adjustment of spring constant of each of the springs and thereby enhancing selection freedom of vibration frequency.

Accordingly, in the vibration electricity generation device 10 configured to generate induced electromotive force by using vibration, selection freedom of vibration frequency can be enhanced even if the vibration electricity generation device 10 is reduced in size with respect to the vibration direction. The movable unit 40 is thereby enabled to be operated by a vibration frequency with a good power generation efficiency

Since the two pairs of coil spring sets 12L and 12R are arranged in the right and left direction (the direction perpendicular to the vibration direction), the movable unit 40 is enabled to be operated in a smoother manner and selection freedom of vibration frequency can be enhanced.

The fixed unit 20 includes the plate coil holder 24 extending in the up and down direction and the conductive coil 22 supported on the coil holder 24. The movable unit 40 includes the magnet holders 46A and 46B surrounding the coil holder 24 and the two pairs of magnets 42 supported on the magnet holders 46A and 46B on the front and back sides of the coil holder 24 (on both sides of the plate coil holder 24 with respect to the plate thickness direction). The two pairs of coil spring sets 12L and 12R are arranged on the right and left sides of the coil holder 24 (on both sides of the plate coil holder 24 with respect to the direction perpendicular to the plate thickness of the coil holder 24). Such configuration enables the movable unit 40 to be operated in a further smoother manner.

The coil springs sets 12L and 12R respectively have the first and second coil springs 12L1, 12L2, 12R1, and 12R2 reversely directed in the up and down direction. The combination of the coil springs sets 12L and 12R improves spring function, further enhancing selection freedom of vibration frequency.

The position where the first coil springs 12L1 and 12R1 are coupled to the movable unit 40 may be at the lower end of the movable unit 40 (the end of the movable unit 40 on the opposite side of the position where the first coil springs 12L1 and 12R1 are coupled to the fixed unit 20 with respect to the up and down direction). The position where the second coil springs 12L2 and 12R2 are coupled to the movable unit 40 may be at the upper end of the movable unit 40 (the end of the movable unit 40 on the opposite side of the position where the second coil springs 12L2 and 12R2 are coupled to the fixed unit 20 with respect to the up and down direction). Such configuration allows the length of the coil springs 12L1, 12L2, 12R1, and 12R2 to be extended, further enhancing selection freedom of vibration frequency.

The first coil springs 12L1 and 12R1 are respectively configured to be inserted in the insertion hole 46b1 and the second coil springs 12L2 and 12R2 are respectively configured to be inserted in the insertion hole 46b2. Such configuration prevents the movable unit 40 from being increased in size in the right and left direction.

The coil holder 24 has the friction reducing films 24B adhered to the front and back sides of the holder body 24A. The films 24B protects a smooth vibration of the movable unit 40 even in the case the magnet holders 46A and 46B and the magnets 42 are brought into contact with the coil holder 24.

Further, even in the case the movable unit 40 slants in the front and back direction while moving in the up and down direction, the magnet holders 46A and 46B may be brought into contact with the friction reducing films 24B before any of the first and second springs 12L1, 12L2, 12R1, and 12R2 are brought into contact with the inner wall of any of the insertion holes 46b1 and 46b2. Such configuration enables the movable unit 40 to be operated in a smoother manner.

The first coil springs 12L1 and 12R1 and the second coil springs 12L2 and 12R2 may be different in spring constant. For example, the second coil springs 12L2 and 12R2 may be of a larger spring constant by the weight of the movable unit 40.

The coil springs sets 12L and 12R may include another coil spring in addition to the first and second coil springs 2L1, 12L2, 12R1, and 12R2.

The vibration electricity generation device 10 may be used as a power generating device for illumination in a bag, a walking stick, and a fishing lure and as a vibration sensor mounted on a bridge. The vibration electricity generation device 10 may be mounted in such a manner that the movable unit 40 vibrates in another direction but the up and down direction.

Another embodiment of the invention is being described.

The first modified embodiment of the invention is being described.

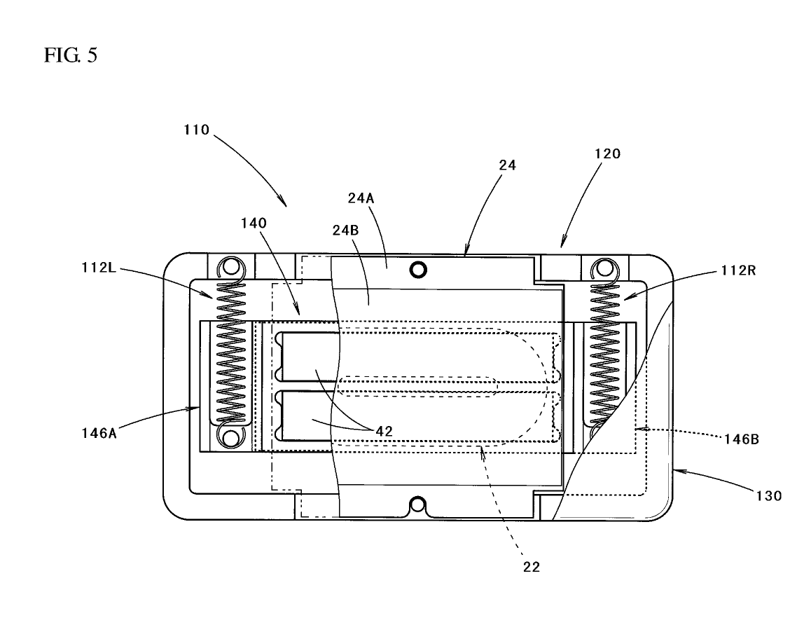

FIG. 5 is a similar view to FIG. 1 showing a vibration electricity generation device 110 of the first modified embodiment.

The basic configuration of the vibration electricity generation device 110 is the same as the vibration electricity generation device 10 but the coil springs sets 12L and 12R are respectively replaced by coil springs 112L and 112R.

The coil springs 112L and 112R respectively corresponds to the first coil springs 12L1 and 12R1. A housing 130 of a fixed unit 120 and magnet holders 146A and 146B of a movable unit 140 may be configured in a smaller width in the left and right direction.

When the movable unit 140 is in a neutral position with respect to the vibration direction, the coil springs 112L and 112R are subject to tension by the weight of the movable unit 140, thereby positioning the movable unit 140 at the center of the housing 130 in the up and down direction.

The modified embodiment achieves the same advantageous effects as the embodiment.

The modified embodiment enables the vibration electricity generation device 110 to be configured in a smaller size.

The second modified embodiment of the invention is being described.

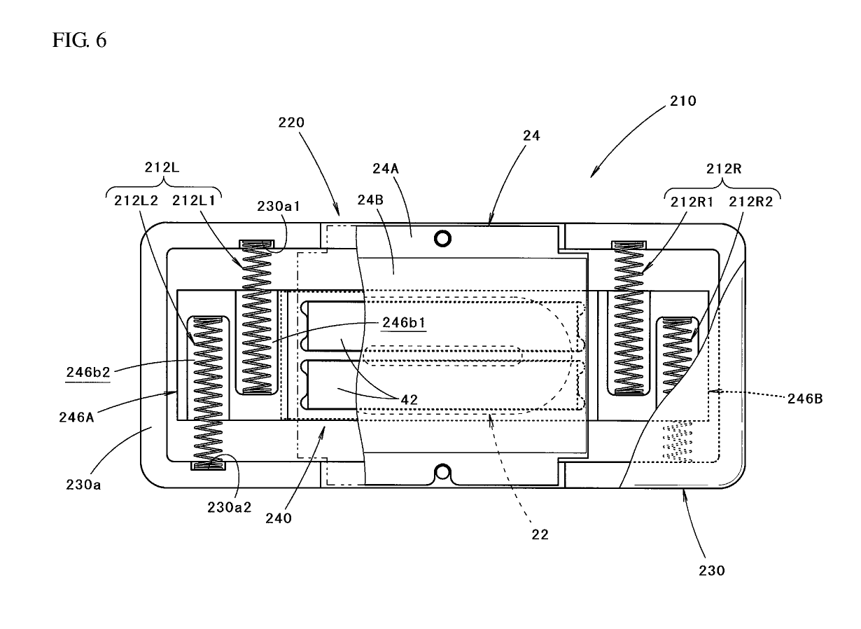

FIG. 6 is a similar view to FIG. 1 showing a vibration electricity generation device 210 of the second modified embodiment.

The basic configuration of the vibration electricity generation device 210 is the same as the vibration electricity generation device 10 but first and second coil springs 212L1, 212L2, 212R1, and 212R2 constituting coil springs sets 212L and 212R are compression coil springs.

The coil springs 212L1, 212L2, 212R1, and 212R2 are of the same configuration.

A movable unit 240 has magnet holders 246A and 246B partly different from the magnet holders 46A and 46B in configuration, specifically at the left and right ends thereof.

A pair of insertion holes 246b1 and 246b2 are formed at the left and right ends of the magnet holders 246A and 246B instead of the pair of insertion holes 46b1 and 46b2.

The coil spring set 212L on the left side of the coil holder 24 includes the first coil spring 212L1 on the right side and the second coil spring 212L2 on the left side. The first coil spring 212L1 is inserted in the insertion hole 246b1 with the upper end thereof abutting against a housing 230 of a fixed unit 220 and the lower end thereof abutting against the magnet holders 246A and 246B. The second coil spring 212L2 is inserted in the insertion hole 246b2 with the lower end thereof abutting against the housing 230 of the fixed unit 220 and the upper end thereof abutting against the magnet holders 246A and 246B.

Specifically, the upper end of the first coil spring 212L1 abuts against the top surface of a recess 230a1 formed in a surrounding wall 230a of the housing 230 while the lower end thereof abuts against the bottom surface of the insertion hole 246b1 at the lower end of the magnet holders 246A and 246B. The lower end of the second coil spring 212L2 abuts against the bottom surface of a recess 230a2 formed in the surrounding wall 230a of the housing 230 while the upper end thereof abuts against the top surface of the insertion hole 246b2 at the upper end of the magnet holders 246A and 246B.

The first and second coil springs 212L1 and 212L2 with the upper and lower end thereof respectively abutting against the surfaces are compressed into elastic deformation, thereby subject to certain pre-compression force imparted thereto when the movable unit 240 is at the neutral position with respect to the vibration direction. The pre-compression force is set to the magnitude not to fall below zero even in the case the movable unit 240 is operated at the maximum amplitude.

The first and second coil springs 212R1 and 212R2 constituting the coil springs set 212R on the right side of the coil holder 24 are similar to those of the coil springs set 212L in configuration and in coupling structure with respect to the fixed unit 220 and the movable unit 240.

The modified embodiment achieves the same advantageous effects as the embodiment.

The modified embodiment enables the vibration electricity generation device 210 to be configured in a compact size.

The first and second coil springs 212L1, 212L2, 212R1, and 212R2 may be in a coaxial arrangement with the first coil springs 212L1 and 212R1 being different from the second coil springs 212L2 and 212R2 in winding diameter.

It is to be understood that any value shown in the embodiment and the modified embodiment is only an example and may be appropriately replaced by another value.

It is to be understood that the invention is not limited to the disclosed embodiments, but intended to cover various modifications and equivalent arrangements within the spirit and scope of the appended claims.

What is claimed is:

1. A vibration electricity generation device of the invention comprising a fixed unit and a movable unit supported on the fixed unit via a coil spring to vibrate against resilient force of the coil spring thereby generating induced electromotive force,
wherein the coil spring is coupled to the movable unit in a position apart from the center position of the movable unit with respect to the vibration direction toward the opposite side of the position where the coil spring is coupled to the fixed unit.

2. The vibration electricity generation device of claim 1, wherein the position where the coil spring is coupled to the movable unit is at the end of the movable unit on the opposite side of the position where the coil spring is coupled to the fixed unit.

3. The vibration electricity generation device of claim 1, wherein the coil spring comprises a coil springs set including a first coil spring and a second coil spring reversely directed to each other.

4. The vibration electricity generation device of claim 2, wherein the coil spring comprises a coil springs set including a first coil spring and a second coil spring reversely directed to each other.

5. The vibration electricity generation device of claim 1, wherein the coil spring is each arranged in a plurality of positions with respect to a direction perpendicular to the vibration direction.

6. The vibration electricity generation device of claim 2, wherein the coil spring is each arranged in a plurality of positions with respect to a direction perpendicular to the vibration direction.

7. The vibration electricity generation device of claim 3, wherein the coil spring is each arranged in a plurality of positions with respect to a direction perpendicular to the vibration direction.

8. The vibration electricity generation device of claim 4, wherein the coil spring is each arranged in a plurality of positions with respect to a direction perpendicular to the vibration direction.

9. The vibration electricity generation device of claim 5, wherein the fixed unit comprises a plate coil holder extending in the vibration direction and a conductive coil supported on the coil holder;
the movable unit comprises a magnet holder surrounding the coil holder and at least one pair of magnets supported on the magnet holder at both sides of the plate coil holder with respect to the plate thickness direction; and
the coil spring is arranged on both sides of the coil holder with respect to the direction perpendicular to the plate thickness direction.

10. The vibration electricity generation device of claim 6, wherein the fixed unit comprises a plate coil holder extending in the vibration direction and a conductive coil supported on the coil holder;
the movable unit comprises a magnet holder surrounding the coil holder and at least one pair of magnets supported on the magnet holder at both sides of the plate coil holder with respect to the plate thickness direction; and
the coil spring is arranged on both sides of the coil holder with respect to the direction perpendicular to the plate thickness direction.

11. The vibration electricity generation device of claim 7, wherein the fixed unit comprises a plate coil holder extending in the vibration direction and a conductive coil supported on the coil holder;
the movable unit comprises a magnet holder surrounding the coil holder and at least one pair of magnets supported on the magnet holder at both sides of the plate coil holder with respect to the plate thickness direction; and
the coil spring is arranged on both sides of the coil holder with respect to the direction perpendicular to the plate thickness direction.

12. The vibration electricity generation device of claim 8, wherein the fixed unit comprises a plate coil holder extending in the vibration direction and a conductive coil supported on the coil holder;
the movable unit comprises a magnet holder surrounding the coil holder and at least one pair of magnets supported on the magnet holder at both sides of the plate coil holder with respect to the plate thickness direction; and
the coil spring is arranged on both sides of the coil holder with respect to the direction perpendicular to the plate thickness direction.
